(19) United States
(12) Patent Application Publication
(10) Pub. No.: US 2005/0069841 A1
(43) Pub. Date: Mar. 31, 2005

(54) Teaching methods and apparatus for encouraging savings by children in banks

(76) Inventors: Hun C. Lee, Pasadena, CA (US); Eun H. Lee, Aurora, CO (US); Sung L. Phillips, San Diego, CA (US); Sunga Lee, Boulder, CO (US)

Correspondence Address: James E. Brunton, P. O. Box 29000, Glendale, CA, 91209, US

(21) Appl. No.: 10/660,126

(22) Filed: Sep. 10, 2003

(51) Int. Cl. G09B 19/18

(52) U.S. Cl. 434/107

(57) ABSTRACT

A method and apparatus for teaching the rudiments of banking and for teaching the importance of savings. The apparatus of the invention, which comprises a modified banking establishment that includes a specially designed children's teller window that is easily accessible by children, includes a specially designed savings book that can be used by children in depositing monies into and withdrawing monies from the banking establishment. Additionally, the apparatus includes a publication describing in simple terms the way banks operate and the type of services they provide, and a plurality of prizes that can be awarded to a child upon the child achieving certain predetermined savings goals.

### BACKGROUND OF THE INVENTION

1. Field of the Invention

The present application relates generally to methods and apparatus for teaching children banking. More particularly, the invention concerns methods and apparatus to be implemented by banking establishments for teaching banking methods and for encouraging savings by children.

2. Discussion of the Prior Art

Traditionally, banking establishments have geared their facilities and banking procedures toward their adult customers. In the conduct of normal operation banks generally provide one or more tellers that are located in a central area of the bank and are primarily responsible for the direct handling of money received from or paid out to adult customers. Most banking facilities are laid out in a similar manner and generally have a plurality of in-line counter-like teller windows behind which the bank tellers stand. The tellers sequentially service customers that wait in queue in an area located adjacent the tellers' stations.

In recent years, primarily due to state and federal regulations, many banks have modified their facilities to better accommodate certain types of customers. For example, changes have been made to provide better handicapped access to the bank parking facility, to provide handicapped parking areas and to lower the counter portion of one or more teller stations to better accommodate persons in wheelchairs. However, virtually nothing has been done in the banking community to provide special facilities to better accommodate children or to implement programs and procedures for teaching children about banking and to encourage children to save money. It is this deficiency that the present invention seeks to address.

Clearly, it is in the interest of banking establishments to better accommodate children's savings programs because evidence has shown that if customers can be secured at an early age there is a substantial probability that they will remain with the bank throughout their teen and adult years. Accordingly, some banks have recently shown interest in taking steps to attract youthful customers. By way of example, the invention of U.S. Pat. No. 6,454,570 issued to Woods seeks to encourage banking by children by providing and discloses an educational banking apparatus which comprises a compartment for storing money, an aperture to allow money to be deposited into the apparatus and an outlet to allow money to be withdrawn from the apparatus. The Woods invention also includes balance determination means for determining the amount of money stored in the apparatus and communication means to allow transmission of balance information over a network to a remote location.

As will be better understood from the discussion which follows, the apparatus of the present invention includes the provision within a banking establishment of a specially designed children's teller window that is easily accessed by the child and is uniquely decorated to attract the child and to make the child feel comfortable within the banking environment. The apparatus of the present invention also includes savings books and cards that are specially designed for use by children and comprises a portable novelty bank for use by the child in home savings and for transporting money to the bank for deposit. Additionally, the apparatus of the invention includes a savings incentive chart and a plurality of incentive-type articles that can be awarded to the child upon the attainment of identified savings goals.

In accordance with the methods of the present invention, children are taught the rudiments of banking and importance of savings through use of the apparatus of the invention, including the children's teller window, the children's savings book, the portable savings bank, the savings incentive chart, and the plurality of prizes or incentive articles that can be awarded to the child when saving goals have been met.

### SUMMARY OF THE INVENTION

It is an object of the present invention to provide a method and apparatus for teaching children the rudiments of banking and teaching the importance of savings. Another object of the invention is to provide apparatus of the aforementioned character which comprises a modified banking establishment that includes a specially designed children's teller window that is easily accessible by children.

Another object of the invention of is to provide apparatus for teaching the children the rudiments of banking which includes a specially designed savings book that can be used by children in depositing monies into and withdrawing monies from the banking establishment.

Another object of the invention is to provide apparatus for teaching the children the rudiments of banking which includes a publication describing in simple terms the way banks operate and the type of services they provide.

Another object of the invention is to provide apparatus of the class described which includes a plurality of prizes that can be awarded to a child upon the child achieving certain predetermined savings goals.

Another object of the invention is to provide apparatus as described in the preceding paragraph which includes a publication identifying the savings goals that must be achieved in order for the child to be awarded a selected one of the plurality of prizes.

Another object of the invention is to provide teaching methods which use the apparatus of the invention to teach children how banks operate, how to interface with a banking establishment and how to use a bank savings book.

These and other objects of the invention of will be achieved using the apparatus of the invention to practice the methods of the invention, the details of which will be described in the paragraphs which follow.

### BRIEF DESCRIPTION OF THE DRAWINGS

FIG. 1 is a generally perspective view of a portion of the inside of a bank having a specially designed teller's window that is accessible to a child.

FIG. 2 is a generally perspective view of one form of the child's savings book of the invention.

FIG. 3 is a generally perspective view of a portable bank that can be used by a child for home savings and for transporting money to and from the bank.

FIG. 4 is a generally perspective view of a publication provided by the bank for teaching a child banking procedures.

FIG. 5 is a generally diagrammatic view of an award chart provided by the bank for identifying awards available to the child when certain savings goals are realized.

FIG. 6, when considered as a whole, illustrates the various prizes that can be awarded to the child by the bank upon the child reaching certain savings goals.

### DISCUSSION OF THE INVENTION

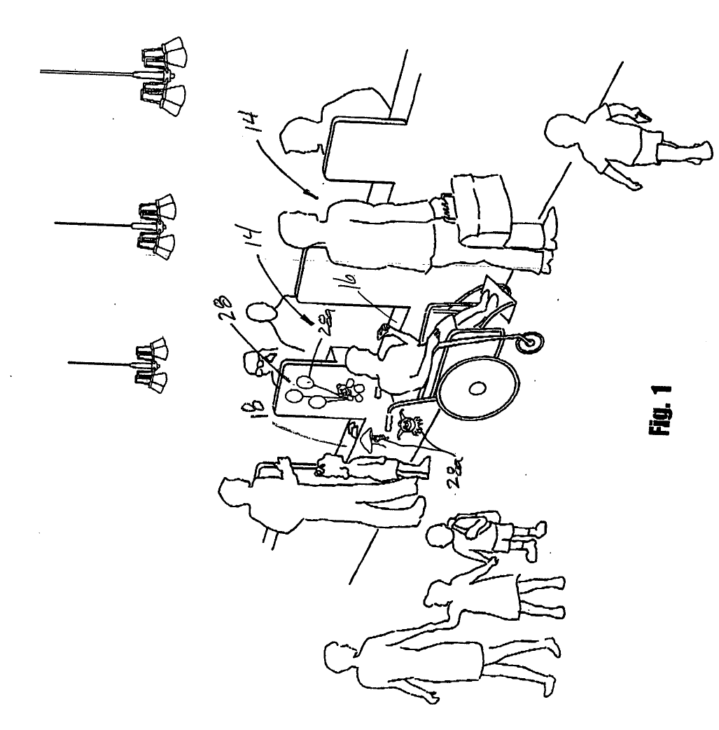

Referring to the drawings and particularly to FIGS. 1 through 4, portions of one form of the apparatus of the present invention are there shown. More particularly, FIG. 1 illustrates one form of a modified banking establishment of the invention, which includes a plurality of teller windows 14 that are arranged in the conventional linear fashion. One of the teller windows, namely the teller window shown in the central portion of FIG. 1 includes a lower counter 16 which is accessible to a handicapped person in a wheelchair. Another of the windows, namely the window shown in the left-hand portion of FIG. 1, illustrates a window, which is specially designed for access by children and includes a lowered counter 18. As illustrated in FIG. 1, this specially designed children's window is readily accessible to a child of small stature so as to allow the child to conveniently deposit and withdraw money from the banking establishment.

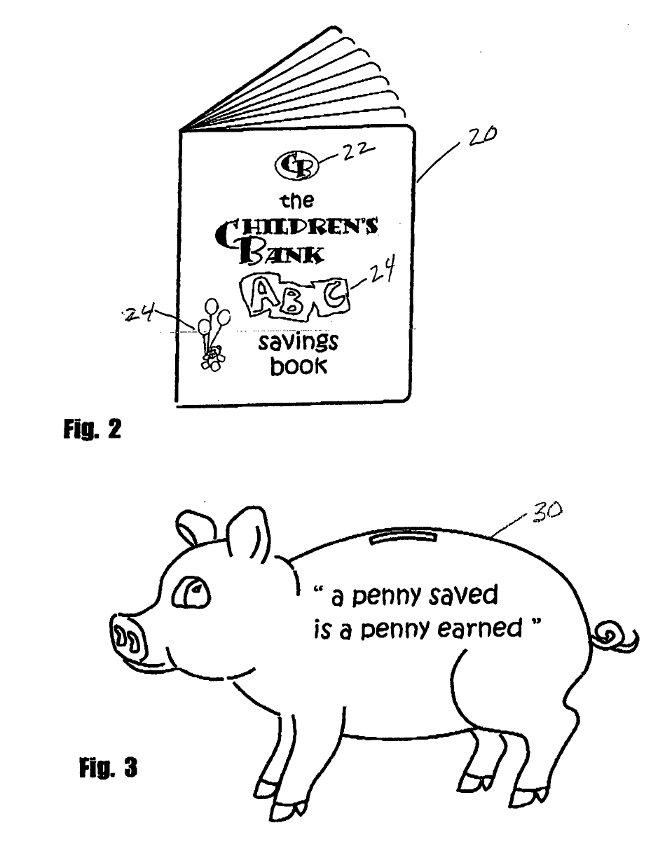

Also forming a part of the apparatus of the present invention is a children's savings book 20 which, as shown in FIG. 2, includes the bank logo 22 and indicia 24 that are attractive to children. The children's savings book can take on various forms, but preferably has the general configuration of the conventional type of savings book that the child would likely use as an adult.

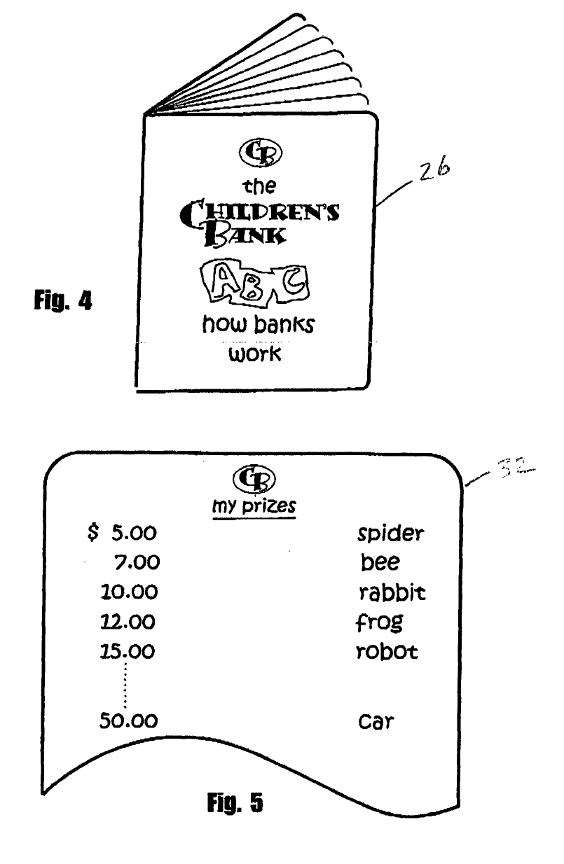

As illustrated in FIG. 4 the drawings, the apparatus of the present form of the invention also includes a publication in the form of a small booklet 26 that is specially designed to teach children banking procedures and to provide information concerning the various services offered by the bank.

In accordance with one form of the method of the invention, the bank teller stationed at the children's window will use booklet 26 as well as the children's bankbook 20 to instruct children initially coming to the banking establishment in the rudiments of the banking procedures.

To encourage the child to adopt good savings habits and to incentivize savings by the child, a plurality of specially designed articles are used by the banking establishment. One of these articles is a portable bank designed to retain money therewithin for use by the child in transporting money to the banking establishment and for deposit by the child at the specially designed children's teller window which includes side panels 28 that are preferably provided with colorful designs 28a which are attractive to the child (FIG. 1). As shown in FIG. 3 of the drawings, in the present form of the apparatus of the invention, this portable bank is specially designed in the configuration of a fanciful “piggy bank” 30 that is configured in a design familiar to the child.

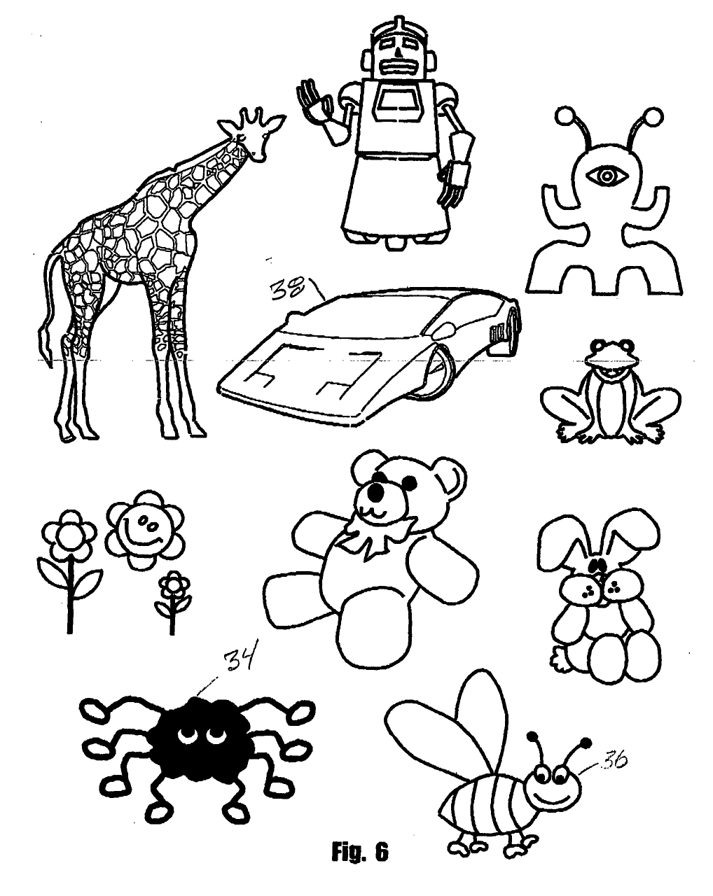

Other articles used by the bank to incentivize savings by the child comprise a plurality of prizes such as those illustrated in FIG. 6 of the drawings. Associated with the prizes shown in FIG. 6 is a publication 32, which is of character shown in FIG. 5 of the drawings and which is designed to establish specific savings goals for the child. More particularly, as shown in FIG. 5, publication 32 identifies specific dollar savings goals which, when achieved by the child, will result in the awarding by the bank of a selected one of the plurality of toys or prizes shown in FIG. 6 of the drawings. For example, when the child has saved five dollars, the bank will award to the child the spider prize 34 which is of the character shown in FIG. 6. Similarly, when the child saves seven dollars he will be awarded the toy 36 which is in the shape of a bee. When the child savings reach fifty dollars, the child will be awarded the toy car 38, which is of the character shown in FIG. 6. It is to be understood that with the passage of time the character of the prizes will change and new award publications will, from time to time, be printed and distributed to customers.

As previously discussed herein, the methods of the present invention are directed toward teaching children the rudiments of banking and the importance of savings. These methods involve the use of the apparatus of the invention, the character of which has been described in the preceding paragraphs of. More particularly, one form of the method of the invention of comprises the steps of first, permitting the child access to said children's teller window where the child is provided with the children's savings book 20. At the same time, the child is preferably provided with the publication 26 which describes how banks work. At this time, the teller at the children's window preferably reviews with the child both the savings book 20 and the publication 26 and encourages the child to further study the publications at home. Additionally, at the first visit to the bank, the child is provided with the portable savings bank, or piggy bank 30. To encourage the child to deposit money in the portable savings bank, the child is provided with the savings incentive chart 32 and is allowed to view the various prizes that can be awarded to the child, such as the prizes illustrated in FIG. 6. At this time the child is given the publication 32 (FIG. 5) and the children's teller explains to the child the various savings goals and the prizes that can be awarded to the child when the child reaches each of the savings goals.

When the child visits the bank the second time, the child will likely have achieved one or more of the savings goals and, following removal of the money from the piggy bank and the deposit of the money into the bank using the savings book, the child will be given the appropriate prize corresponding to the amount of money saved and deposited. Through repetition of these steps the child will not only learn basic banking procedures, but will also learn that by achieving savings goals, valuable awards can be received. If the personnel within the banking establishment are successful in working with the child, it is likely that the child will continue patronizing the bank throughout the teen and adult years.

A by product of the methods of the present invention is the overall attractiveness of the programs of the invention to the parents of the children. Clearly, the banking establishment, through advertising the programs, will be likely to attract not only new children customers, but their parents as well.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. In combination with a banking establishment, an apparatus for teaching banking procedures to children, the apparatus comprising:
(a) a plurality of teller windows at least one of which comprises a children's window which is accessible to a child of small stature to allow the child to deposit and withdraw money from the banking establishment;
(b) a specifically designed savings book usable by the child to record deposits and withdrawals of money from the bank;
(c) a portable bank designed to retain money therewithin for use in transporting the money to the banking establishment and for retrieval by the child at the teller window accessible to the child; and
(d) a plurality of prizes designed to provide incentives to the child to save money and to be awarded to the child upon attainment of specified savings goals.

2. The apparatus as defined in claim 1 further including a publication designed to teach the child banking procedures.

3. The apparatus as defined in claim 1 further including a publication designed to establish a plurality of savings goals by awarding at least one of said plurality of prizes upon attaining at least one of said plurality of specified savings goals.

4. The apparatus as defined in claim 1 in which said children's window includes side panels provided with illustrations attractive to children.

5. The apparatus as defined in claim 1 in which said portable bank comprises a portable bank in the general shape of a small pig.

6. In combination with a banking establishment, an apparatus for teaching banking procedures to children, the apparatus comprising:
(a) a plurality of teller windows at least one of which comprises a children's window which is accessible to a child of small stature to allow the child to deposit and withdraw money from the banking establishment;
(b) a publication designed to teach children banking procedures;
(c) a savings book usable by the child to record deposits and withdrawals of money from the bank, said savings book having a cover provided with illustrations attractive to the child;
(d) a portable bank designed to retain money therewithin for use in transporting the money to the banking establishment and for retrieval by the child at the teller window accessible to the child;
(e) a publication designed to establish a plurality of savings goals by awarding at least one of said plurality of toys upon attaining at least one of said plurality of savings goals; and
(f) a plurality of toys designed to provide incentives to the child to save money and to be awarded to the child upon attainment of said savings goals.

7. The apparatus as defined in claim 6 in which said children's window includes side panels provided with illustrations attractive to children.

8. The apparatus as defined in claim 7 in which said portable bank comprises a portable bank in the general shape of a small pig.

9. A method for teaching children the rudiments of banking and the importance of savings through use of an apparatus comprising a children's teller window, a publication describing how banks operate, a children's savings book, a portable savings bank, a savings incentive chart, and a plurality of prizes, said method comprising the steps of:
(a) permitting the child access to said children's teller window;
(b) providing to the child said children's savings book;
(c) providing to the child said savings incentive chart;
(d) providing to the child said portable savings bank; and
(e) allowing the child to view said plurality of prizes and explaining to the child the steps to be followed prior to being awarded a selected one of said plurality of prizes.

10. The method as defined in claim 9 including the further step of providing to the child said publication describing how banks operate.

11. The method as defined in claim 10 further including the step of teaching the child how to use said children's savings book.
